(19) United States
(12) Patent Application Publication
(10) Pub. No.: US 2022/0284088 A1
(43) Pub. Date: Sep. 8, 2022

(54) AUTHENTICATION OF WRITE REQUESTS

(71) Applicant: Hewlett-Packard Development Company, L.P., Spring, TX (US)

(72) Inventors: Hung Hua Peng, Taipei City (TW); Stanley Hyojun Park, Spring, TX (US); Rajesh Arvind Shah, Spring, TX (US)

(73) Assignee: Hewlett-Packard Development Company, L.P., Spring, TX (US)

(21) Appl. No.: 17/636,062

(22) PCT Filed: Oct. 24, 2019
(86) PCT No.: PCT/US2019/057772

§ 371 Date: Feb. 17, 2022

(51) Int. Cl. G06F 21/44; G06F 21/57

(52) U.S. Cl. CPC G06F 21/44; G06F 21/575; G06F 2221/03

(57) ABSTRACT

Examples of computing devices for authenticating a write request to a controller of a computing device are described herein, in an example, a computing device may include a controller having a first authentication key and a firmware having a copy of the first authentication key. The copy of the first authentication key being editable. The controller may randomly generate a second authentication key. Using the first authentication key and the second authentication key, the controller may compute a first hash value. The firmware may compute a second hash value using the copy of the first authentication key and the second authentication key. When the controller receives a write request, the controller may compare the first hash value and the second hash value and allow the write request upon successful comparison.

### BACKGROUND

Computing devices, such as personal computers, laptops, notebooks, etc., include controllers which control various tasks and operate various components in the computing devices. For example, a controller may control a keyboard/mouse interface, a battery, a charger of a computing device, and so on. In addition, the controller may be accessed by firmware of the computing device to request information pertaining to the components which are being operated.

### BRIEF DESCRIPTION OF FIGURES

The detailed description is provided with reference to the accompanying figures, wherein:

FIG. 1 illustrates a computing device for authenticating a write a request to a controller, according to an example;

FIG. 2 illustrates a computing device for authenticating a write request to a controller, according to an example;

FIG. 3 illustrates a computing device for authenticating a write request to a controller, according to an example;

FIG. 4 illustrates a call flow diagram for authenticating a write request to a controller, according to an example; and

FIG. 5 illustrates a non-transitory computer readable medium for authenticating a write request to a controller, according to an example.

### DETAILED DESCRIPTION

Computing devices, such as laptops, desktop computers, notebooks, etc. include controllers that may be in communication with various input/output devices, such as a keyboard, a mouse, and so on, and may control various tasks and operate various components of the computing devices. A controller may be accessed by firmware of a computing device or third-party tools, to write to or read from the controller. The controller may be accessed through an input/output Interface, such as Host Embedded Controller Interface (HECI). In an example, the firmware may read data pertaining to handling of power consumption in the computing device via the HECI. In another example, the third-party tools may access the HECI to perform testing of certain components, such as a battery and shared memory.

As there is no mechanism to ensure that only trusted parties may access the controller, any party (authorised or unauthorised) may read from and write to the controller via the HECI. Such unchecked access to the controller may allow an attacker to write malicious code in the controller thereby compromising the data stored in the controller. To keep a check on the parties that are accessing the controller, key exchange techniques may be employed. The key exchange techniques may involve exchange of cryptographic keys between two parties. Such exchange of cryptographic keys may not be robust against malware attack and may be susceptible to man-in-the-middle attacks. Thus, the key exchange techniques may pose a constant threat on integrity of data being stored in the controller.

The present subject matter discloses example approaches for authenticating a write request to a controller of a computing device. For example, the controller may compare hash values generated by the controller and a firmware to ensure that write requests received from the firmware are being executed.

The present subject matter describes example computing devices for authenticating a write request to a controller of a computing device. As per the present subject matter, a first authentication key may be stored in the controller and a copy of the first authentication key may be stored in the firmware. The first authentication key stored in the controller may be non-editable whereas the first authentication key stored in the firmware may be editable. Upon booting up of the computing device, the controller may randomly generate a second authentication key. Further, the second authentication key may be periodically refreshed upon expiration of a particular time interval after booting up of the computing device.

The controller and the firmware may generate a first hash value and a second hash value respectively, based on the combination of the two keys. The first hash value is generated using the first authentication key and the second authentication key as stored in the controller. Further, the second hash value is generated using the copy of the first authentication key and the second authentication key as stored in the firmware. Upon receiving a write request from the firmware, the controller may compare the first hash value with the second hash value and may authenticate the write request upon successful comparison of the first hash value and the second hash value.

Accordingly, the present subject matter facilitates in ensuring the authenticity of the write operations being performed on the controller. Further, the periodic refreshing of the second authentication key may provide robustness to the authentication process as the second authentication key keeps on changing.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

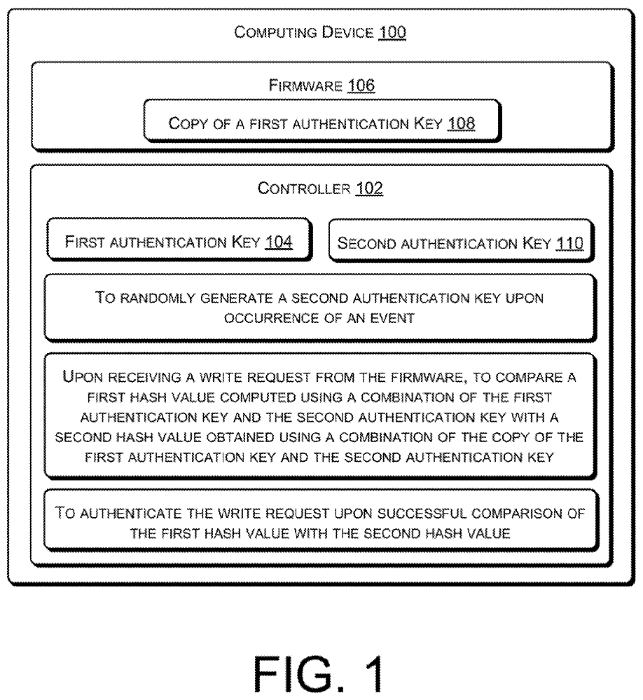

The manner in which the computing devices are implemented are explained in detail with respect to FIGS. 1-5, While aspects of described computing devices can be implemented in any number of different electronic devices, environments, and/or implementations, the examples are described in the context of the following system(s). It is to be noted that drawings of the present subject matter shown here are for illustrative purposes and are not drawn to scale.

FIG. 1 illustrates a computing device 100 for authenticating a write request to a controller 102, according to an example. Examples of the computing device 100 may include, but are not limited to, a laptop computer, a notebook computer, a tablet, and a mobile phone. The controller 102 of the computing device 100 may be implemented as an embedded controller, a microcontroller, a microprocessor, a functional block, logic, or other circuit or collection of circuits capable of performing the functions described herein. In an example, the controller 102 may include a first authentication key 104. The first authentication key 104 may be non-editably stored in the controller 102.

The computing device 100 may also include a firmware 106 that may be coupled to the controller 102. The firmware 106 may include a program that may be written to a non-volatile memory (not shown) of the computing device 100. Examples of the firmware 106 may include Basic input/output System (BIOS) or Unified Extensible Firmware Interface (UEFI). The firmware 106 may include a copy of the first authentication key 108. The copy of the first authentication key 108 may be editable. For example, the copy of the first authentication key 108 may be altered or modified by a third party. In an example, the first authentication key 104 is stored in the controller 102 during compilation of the firmware in the computing device 100. Therefore, the first authentication key may be a secret key which is not known to anyone except the controller 102. In an example, the first authentication key 104 may be shared between the controller 102 and the firmware 106 through asymmetric cryptography.

The controller 102 may randomly generate a second authentication key 110. For example, the second authentication key 110 may be a nonce key. In an example, the controller 102 may employ a random number generator to generate the second authentication key 110. The controller 102 may generate the second authentication key 110 upon occurrence of an event in the computing device 100. The occurrence of the event may act as a trigger that may cause the controller 102 to generate the second authentication key 110. Once generated, the second authentication key 110 may be refreshed periodically. In an example, the controller 102 may notify the firmware 106 about the second authentication key 110.

The controller 102 may compute a first hash value using a combination of the first authentication key 104 and the second authentication key 110. In an example, a hash value may be indicative of a unique value that is generated for a collected set of data, such as the combination of the first authentication key 104 and the second authentication key 110.

In an example, the controller 102 may receive a write request from the firmware 106. The write request may include a write operation for being performed on the controller 102. Upon receiving the write request, the controller 102 may obtain a second hash value from the firmware 106. In an example, the second hash value may be obtained using the copy of the first authentication key 108 and the second authentication key 110. Thereafter, the controller 102 may compare the first hash value and the second hash value. If the comparison is successful, the controller 102 may authenticate the write request. Accordingly, the write operation may be performed on the controller 102.

The comparison of the first hash value with the second hash value facilitates in identifying that the write request is not being sent by an unauthorized user, such as a malware. The computing device 100 thus ensures that the controller 102 is accessed by trusted sources, such as the firmware 106, to perform any write operation. The present subject matter therefore provide a reliable and robust communication between the controller 102 and firmware 106.

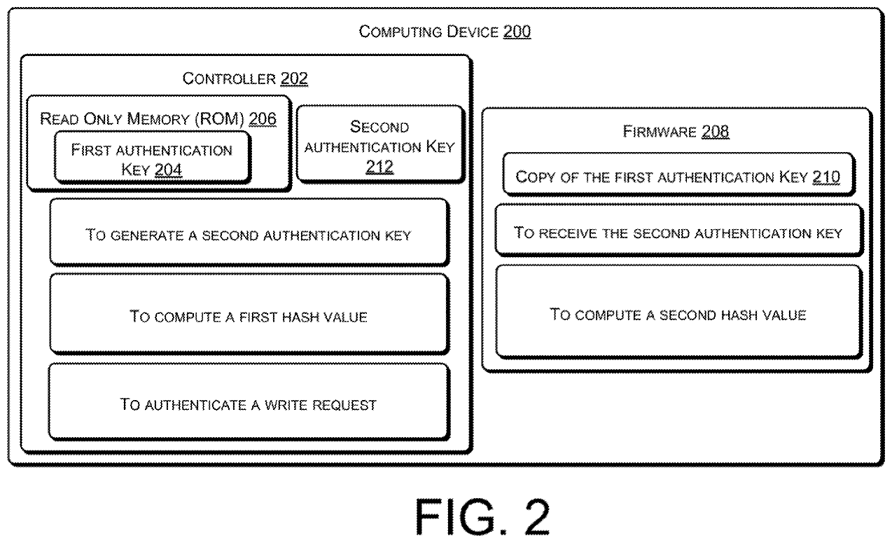

FIG. 2 illustrates a computing device 200 for authenticating a write request to a controller 202, according to an example. In an example, the computing device 200 may be similar to the computing device 100. Further, the controller 202 may be similar to the controller 102. The controller 202 may include a first authentication key 204 stored in a read only Memory (ROM) 206 of the controller 202. Examples of the ROM 206 may include, but are not limited to, non-volatile memories, erasable programmable ROM, flash memories, hard disks, optical disks, and magnetic tapes. In an example, the first authentication key 204 stored in the ROM 206 is non-editable.

The computing device 200 may also include a firmware 246 that may be communicatively coupled to the controller 202. In an example, the firmware 208 may be similar to the firmware 106. The firmware 106 may include a program that may be written to the computing device 100. In an example, the firmware 208 may be written into a non-volatile memory, such as a ROM, flash memory, and so on, of the computing device 200. In an example, the first authentication key 204 may be stored in the controller 202 during compilation of the firmware 208. As the firmware 208 is compiled at the time of manufacturing of the computing device 200, the first authentication key 204 may be non-editably stored in the controller 202.

In an example, the firmware 208 may include a copy of the first authentication key 210. In an example, the copy of the first authentication key 210 may be editable. The term “editable” may indicate that the copy of the first authentication key 210 and may be modified by a user, such as an unauthorized user, by gaining access to the firmware 208.

When the computing device 200 boots up, the controller 202 may randomly generate a second authentication key 212. The second authentication key 212 may be similar to the second authentication key 110 and may be generated as a nonce key. The second authentication key 212 may be valid for each Power-On-Self-Test (POST). Therefore, every time the computing device 200 boots up, the controller 202 may generate a random value as the second authentication key 212. Further, upon booting up of the computing device 200, the controller 202 may refresh the second authentication key 212 in a time interval. In an example, the time interval may be of about 5 minutes to about 10 minutes. In another example, the time interval may be of about 10 minutes to about 15 minutes. In an example, the controller 202 may generate the second authentication key 212 with a hardware random number generator, a software random number generator, or a pseudo-random number generator.

Based on the second authentication key 212, the controller 202 may compute a hash value, for instance, a first hash value based on a combination of the first authentication key 204 and the second authentication key 212. The term “hash value” may be indicative of a numeric value generated for a set of input data, such as the authentication keys, by applying a cryptographically secure hashing algorithm (SHA) to the input data. For example, the SHA generates fixed-length numeric hash values corresponding to inputs of varying lengths.

In an example, upon generation of the second authentication key 212, the controller 202 may share the second authentication key 212 with the firmware 208. Upon receiving the second authentication key 212, the firmware 208 may compute a second hash value based on a combination of the copy of the first authentication key 210 and the second authentication key 212. In an example, when the second authentication key 212 is regenerated or refreshed by the controller 202, the controller 202 may notify the firmware 208 about the newly generated second authentication key. Accordingly, the firmware 208 may update the second hash value.

When a write operation is to be performed on the controller 202, the controller 202 may receive a write request from the firmware 208. To authenticate the write request, the controller 202 may obtain the second hash value from the firmware 208. Thereafter, the controller 202 may compare the first hash value with the second hash value. If the comparison is successful, i.e., the first hash value matches with the second hash value, the controller 202 may ascertain that the write request is sent by the firmware 208. Accordingly, upon successful comparison of the first and the second hash value, the controller 202 may authenticate the write request.

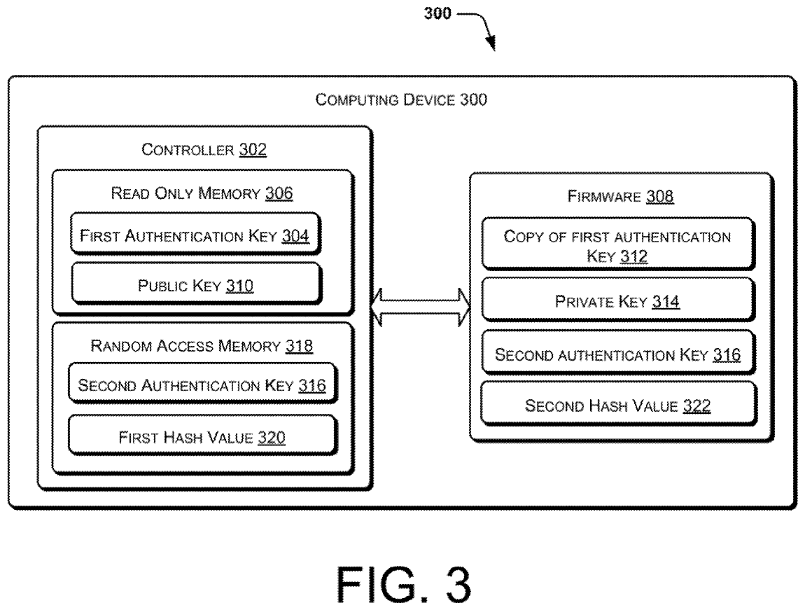

FIG. 3 illustrates a computing device 300 for authenticating a write request to a controller 302, according to an example. Examples of the computing device 300 may include, but are not limited to, a laptop computer, a notebook computer, and a tablet. The controller 302 may be an embedded controller or a microprocessor, which is different from a processor (not shown) of the computing device 300.

The controller 302 may be provided with a first authentication key 304 stored in a read only Memory (ROM) 306 of the controller 302. The ROM 306 may be a non-volatile memory, such as erasable programmable ROM, flash memories, hard disks, optical disks, and magnetic tapes. Therefore, the first authentication key 304 may be permanently stored in the controller 302. The computing device 300 may also include a firmware 308. In an example, the first authentication key 304 is stored in the controller 302 during compilation of the firmware 308. Accordingly, the first authentication key 304 is not known to anyone except for the controller 302.

In an example, the first authentication key 304 may be shared between the controller 302 and the firmware 308 by using asymmetric cryptography. In an example, first authentication key 304 may be shared between the controller 302 and the firmware 308 by using an Rivest-Shamir-Adleman (RSA) technique. For example, the controller 302 may include a public key 310 stored in the ROM 306. The public key 310 may be a cryptographic key that may be used by the controller 302 to encrypt a message intended for a particular recipient.

The firmware 308 may request the controller 302 to share the first authentication key 304 with the firmware 308. For example, the firmware 308 may send a shared memory (SHM) command to the controller 302 seeking the first authentication key 304. In response to the request, the controller 302 may send a message containing a copy of the first authentication key 312 to the firmware 308. In an example, the controller 302 may sign or encrypt a header of the message with the public key 310 before sharing the message with the firmware 308.

In addition, the firmware 308 may include a private key 314 corresponding to the public key 310 of the controller 302. Upon receiving the message, the firmware 308 may decrypt the header of the message by using the private key 314. Based on the decryption, the firmware 308 may extract and store the copy of first authentication key 312, As the firmware 308 has the private key 314 corresponding to the public key 310, the message containing the copy of the first authentication key 312 may not be decrypted by any other entity. In addition, as the first authentication key 304 is shared between the controller 302 and the firmware 308 during compilation of the firmware 308, the first authentication key 304 may act as a secret key that is not known to any other component. The first authentication key 304 and the copy of the first authentication key 312 therefore facilitates in ensuring that any write request to the controller 302 are being sent from an authorized user.

When the computing device 300 is booted up, the controller 302 may generate a second authentication key 316. The second authentication key 316 may be a random key that is generated by a random number generator. The controller 302 may store the second authentication key 316 in a random-access Memory (RAM) 318 of the controller 302. In an example, the RAM 318 may be a volatile memory and may include any non-transitory computer-readable medium known in the art including, such as static random-access memory (SRAM) and dynamic random-access memory (DRAM). In an example, the RAM 318 may be a shared memory.

Once generated, the second authentication key 316 may be refreshed at a regular time interval. For example, the second authentication key 316 may be refreshed after a time interval of about 5 minutes to about 15 minutes. In an example, the time interval of refreshing the second authentication key 316 may vary based on configurations of the controller 302. For example, the time interval may be of about 5 minutes to about 10 minutes. Periodically refreshing the second authentication key 316 may thereby enhance the robustness in authenticating the write requests to the controller 302.

When the second authentication key 316 is generated upon booting up of the computing device 300, the controller 302 may compute a first hash value 320 based on a combination of the first authentication key 304 and the second authentication key 316. A hash value may be indicative of a unique value that is generated for a collected set of data, such as the combination of the first authentication key 304 and the second authentication key 316. In an example, the controller 302 may employ a hashing algorithm to generate the first hash value 320. Examples of the hashing algorithms may include but are not limited to Message Digest algorithm 5 (MD5) and Secure Hash Algorithm (SHA). In an example, the controller 302 may store the first hash value 320 in the RAM 318.

Further, the controller 302 may share the second authentication key 316 with the firmware 308. In an example, the firmware 308 may read the second authentication key 316 from the RAM 318. Using the second authentication key 316 and the copy of the first authentication key 312, the firmware 308 may compute a second hash value 322. As mentioned earlier, the controller 302 may regenerate the second authentication key 316 upon expiration of a particular time interval after booting up of the computing device 300. For example, the controller 302 may generate a new random key after every 10 minutes from the booting up of the computing device 300. Thereafter, the controller 302 may re-compute the first hash value 320 by using the freshly generated second authentication key 316. The controller 302 may also notify the firmware 308, when the second authentication key 316 is refreshed. Based on the notification, the firmware 308 may update the second hash value 322.

When the controller 302 receives a write request from the firmware 308 to perform a write operation on the RAM 318, the controller 302 may obtain the second hash value 322 from the firmware 308. The controller 302 may then compare the first hash value 320 with the second hash value 322, to determine if the write request is received from an authorised user or not. For example, when the firmware 308 sends the write request to the controller 302, the first hash value 320 matches with the second hash value 322, i.e., the comparison is successful.

On the other hand, if a malware or an unauthorised user attempts to perform the write operation on the controller 302, the first hash value 320 may not match with the second hash value 322. For example, the malware may tamper with the data of the firmware 308, such as change the copy of the first authentication key 312 stored in the firmware 308. This may cause the second hash value 322 to vary from the first hash value 320. Such a discrepancy in the hash values may indicate that the firmware 308 is compromised and the write request is not received from a trusted party. Accordingly, the controller 302 may not authenticate the write request.

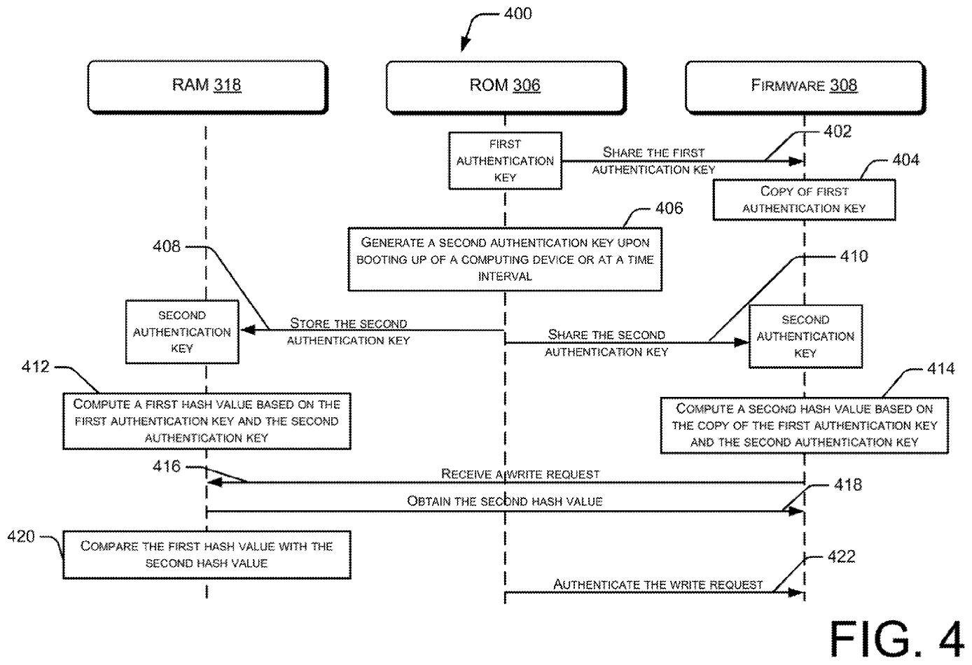

FIG. 4 illustrates a call flow diagram 400 for authenticating a write request to a controller, according to an example of the present subject matter. The various arrow indicators used in the call flow diagram 400 depicts the transfer of data between the ROM 306 of the controller 302, firmware 308, and the RAM 318 of the controller 302. The order in which the call flow diagram 400 is described is not intended to be construed as a limitation, and any number of the described steps may be combined in any order to implement the call flow diagram 400, or an alternative method. Further, certain trivial steps have been omitted in the sequence diagrams, for the sake of brevity and clarity.

Referring to FIG. 4, at step 402, a first authentication key may be shared between the ROM 306 and the firmware 308. In an example, the first authentication key may be shared between the ROM 306 and the firmware 308 by using asymmetric cryptography. Further, at step 404, the firmware 308 may store a copy of the first authentication key as received from the ROM 306.

At step 406, the ROM 306 may generate a second authentication key. For example, the second authentication key may be a nonce key. In an example, the ROM 306 may employ a random number generator to generate the second authentication key. Further, the second authentication key may be randomly generated upon occurrence of an event in the computing device 300. For example, the second authentication key is generated, when the computing device 300 boots up or is started. Therefore, the second authentication key may be valid for each Power-On-Self-Test (POST). Once the computing device has booted up, the ROM 306 may periodically refresh the second authentication key at a regular time interval.

At step 408, the second authentication key is stored in the RAM 318. As mentioned above, the second authentication key is regenerated at a regular time interval, therefore, the RAM 318 may also update the second authentication key regularly.

At step 410, the ROM 306 may share the second authentication key with the firmware 308. In an example, the firmware 308 may read the second authentication key from the RAM 318.

At step 412, the RAM 318 may compute a first hash value based on a combination of the first authentication key and the second authentication key. Further, at step 414, the firmware 308 may compute a second hash value based on a combination of the copy of the first authentication key and the second authentication key.

Further, at step 416, the RAM 318 may receive a write request from the firmware 308. To authenticate whether the write request is received from an authorised user, the RAM 318 may obtain the second hash value from the firmware 308, as depicted at step 418.

Furthermore, at step 420, the RAM 318 may compare the first hash value with the second hash value. In case the first hash value matches with the second hash value, the RAM 318 may authenticate the write request, as depicted in step 422. The successful comparison of the first hash value and the second hash value may indicate that the write request is coming from a trusted source.

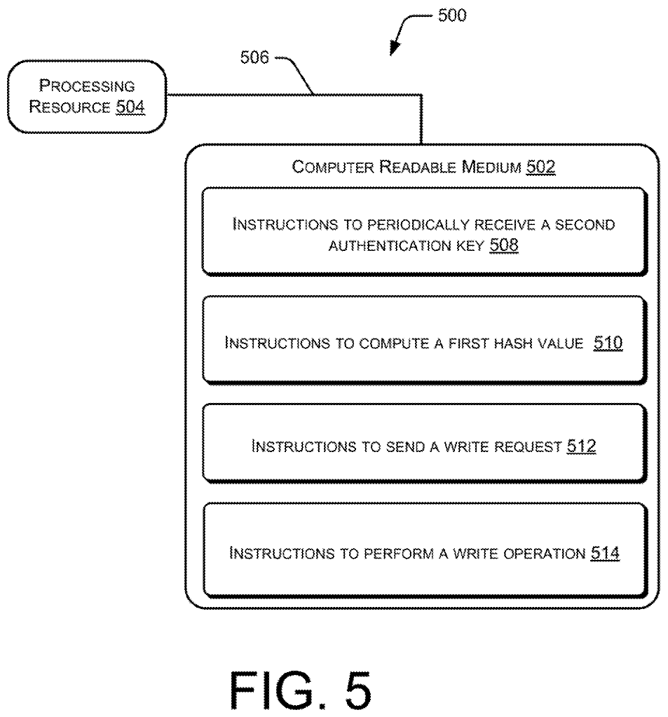

FIG. 5 illustrates an example system environment 500 using a non-transitory computer-readable medium 502 for authenticating a write request to a controller, such as the controller 102, according to an example of the present subject matter. The system environment 500 includes a processing resource 504 communicatively coupled to the non-transitory computer-readable medium 502 through a communication link 506. For example, the processing resource 504 may be a firmware of a computing system, such as the computing device, for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer-readable medium 502 through a network (not shown).

In an example, the non-transitory computer-readable medium 502 includes a set of computer-readable and executable instructions for authenticating a write request to the controller. The set of computer-readable instructions may include instructions as explained in conjunction with FIGS. 1 to 3. The set of computer-readable instructions, referred to as instructions hereinafter, may be accessed by the processing resource 504 through the communication link 506 and subsequently executed to perform acts for authenticating a write request to a controller.

The controller may store a first authentication key. For example, the first authentication key may be non-editably stored in the controller. The firmware may be communicatively coupled to the controller. In an example, the firmware may have a copy of the first authentication key. The copy of the first authentication key may be editable. In an example, the first authentication key is stored during compilation of the firmware in the computing device.

Referring to FIG. 5, in an example, the non-transitory computer-readable medium may include instructions 508 to periodically receive a second authentication key upon expiration of a time interval after booting up of the computing device. For example, the firmware may receive the second authentication key upon expiration of a time interval of about 10 minutes to about 15 minutes. In another example, the time interval may be of about 5 minutes to about 10 minutes. The controller may randomly generate the second authentication key at the particular time interval and share the second authentication key with the firmware so that the firmware may also update the second authentication key. In an example, the firmware may read the second authentication key from a random-access memory (RAM) of the controller. Further, the controller may store the second authentication key in the RAM as the second authentication key is refreshed at a regular time interval.

The non-transitory computer-readable medium 502 may also include instructions 510 to compute a first hash value using a combination of the copy of the first authentication key and the second authentication key. In an example, a hash value indicates a unique identifier or a unique key that is generated for a collected set of data, such as the combination of the copy of the first authentication key and the second authentication key. In an example, the copy of the first authentication key may be editable.

The non-transitory computer-readable medium 502 may include instructions 512 to send a write request to the controller along with the first hash value. In an example, the firmware may send the write request to perform a write operation on the controller.

The non-transitory computer-readable medium 502 may include instructions 514 to perform the write operation indicated in the write request upon authentication of the write request by comparing the first hash value with a second hash value computed by the controller using the first authentication key and the second authentication key. In an example, the firmware and the controller may employ a hashing technique to generate a hash value. The controller may compute the second hash value for the first authentication key and the second authentication key.

Upon receiving the write request, the controller may authenticate a source of the write request. To do so, the controller may compare the first hash value obtained from the firmware with the second hash value computed by the controller using the first authentication key and the second authentication key. Upon successful comparison of the first and the second hash values, i.e.; if the first and the second hash values match, the controller may allow the write request to execute. In case, the first and the second hash values do not match, the controller may reject the write request to execute.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A computing device comprising:
a controller having a first authentication key, the controller is to,
randomly generate a second authentication key upon occurrence of an event in the computing device;
upon receiving a write request from a firmware, compare a first hash value with a second hash value,
wherein the first hash value is computed using a combination of the first authentication key and the second authentication key, and wherein the second hash value is obtained using a combination of a copy of the first authentication key stored in the firmware and the second authentication key, the copy of the first authentication key being editable; and
authenticate the write request upon successful comparison of the first hash value and the second hash value.

2. The computing device as claimed in claim 1, wherein the event is booting up of the computing device.

3. The computing device as claimed in claim 2, wherein the event is expiration of a time interval of about 10 minutes to about 15 minutes after booting up of the computing device.

4. The computing device as claimed in claim 1, wherein the first authentication key is shared between the controller and the firmware using asymmetric cryptography.

5. The computing device as claimed in claim 1, wherein the first authentication key is stored during compilation of the firmware in the computing device.

6. The computing device as claimed in claim 1, wherein the second authentication key is stored in a Random-Access Memory (RAM) of the controller.

7. A computing device comprising:
a controller having a first authentication key, the first authentication key being non-editably stored in a Read Only Memory (ROM) of the controller, the controller is to,
randomly generate a second authentication key upon booting up of the computing device;
compute a first hash value based on a combination of the first authentication key and the second authentication key; and
a firmware communicatively coupled to the controller, the firmware having a copy of the first authentication key, the copy of the first authentication key being editable, the firmware is to,
receive the second authentication key from the controller;
compute a second hash value based on a combination of the copy of the first authentication key and the second authentication key,
wherein in response to receiving a write request from the firmware, the controller is to compare the first hash value with the second hash value, wherein the write request is authenticated upon successful comparison.

8. The computing device as claimed in claim 7, wherein the second authentication key is periodically regenerated upon expiration of a time interval after booting up of the computing device.

9. The computing device as claimed in claim 8, wherein the time interval is of about 10 minutes to about 15 minutes.

10. The computing device as claimed in claim 7, wherein the first authentication key is shared between the controller and the firmware using asymmetric cryptography.

11. The computing device as claimed in claim 7, wherein the second authentication key is stored in a Random-Access Memory (RAM) of the controller.

12. A non-transitory computer-readable medium comprising computer-readable instructions, which, when executed by a firmware of a computing device having a copy of a first authentication key, cause the computing device to:
periodically receive a second authentication key upon expiration of a time interval after booting up of the computing device, wherein the second authentication key is randomly generated;
compute a first hash value using a combination of the copy of the first authentication key and the second authentication key, the copy of the first authentication key being editable;
send a write request to a controller along with the first hash value; and
perform a write operation indicated in the write request upon authentication of the write request by comparing the first hash value with a second hash value computed by the controller using the first authentication key and the second authentication key,
wherein the first authentication key is non-editably stored in the controller of the computing device.

13. The non-transitory computer-readable medium as claimed in claim 12, wherein the time interval is of about 10 minutes to about 15 minutes.

14. The non-transitory computer-readable medium as claimed in claim 12, wherein the first authentication key is stored during compilation of the firmware in the computing device.

15. The non-transitory computer-readable medium as claimed in claim 12, wherein the second authentication key is stored in a Random-Access Memory (RAM) of the controller.
